(19) United States
(12) Patent Application Publication
(10) Pub. No.: US 2004/0065019 A1
(43) Pub. Date: Apr. 8, 2004

(54) Connecting device, cover device and dividing element

(75) Inventors: Gregor Haab, Baar (CH); Hans Wuthrich, Wettswil (CH); Peter Wirz, Adilgenswil (CH)

Correspondence Address: OLIFF & BERRIDGE, PLC, P.O. BOX 19928, ALEXANDRIA, VA, 22320, US

(73) Assignee: HAWA AG, Mettmenstetten (CH)

(21) Appl. No.: 10/662,446

(22) Filed: Sep. 16, 2003

(30) Foreign Application Priority Data
Oct. 2, 2002 (EP) 02 405 853.9

(51) Int. Cl. E05D 15/06

(52) U.S. Cl. 49/409

(57) ABSTRACT

The device according to the invention has the purpose of connecting a first component (5) to a second component (12) in a positively locking but detachable fashion, and for sealing a joint region between the first component (5) and a third component (4) which is fixedly connected to the second component (12). According to the invention an elastic element (6) is provided which has

a) a groove (61) for receiving a securing rib (52) which is provided on the first component (5),

b) a latching element (62) which can be connected in a positively locking fashion to the second component (12) by means of pressure force, and

c) a sealing lip (63) which presses against a third component (4) after the latching element (62) latches in.

The first component (5), for example a cover panel, is therefore connected in a positively locking fashion to the elastic element (6) by inserting the securing rib (52), as a result of which the cover panel (5) is connected in a positively locking fashion to the second component (12), for example a profiled component, by means of the elastic element (6). The sealing lip (63) is arranged here on the elastic element (6) in such a way that, after the cover panel (5) has been mounted, it presses against the third component (4), for example a glass panel of a dividing element, which is connected to the profiled part (12).

The invention relates to a connecting device, a cover device which is provided with this connecting device, and a dividing element, in particular a sliding door, according to the preamble of Patent claims 1, 9 and 12.

The invention relates in particular to a cover device by means of which a mounting device which is used to secure a glass panel and may possibly have a visually unattractive appearance is to be covered.

Devices for securing glass panels are known, for example, from WO 02/10544 A1 or EP 0 940 542 A2. These devices have a clamping device with two elements which can be displaced with respect to one another by means of a screw and between which a glass panel is secured in a frictionally locking fashion.

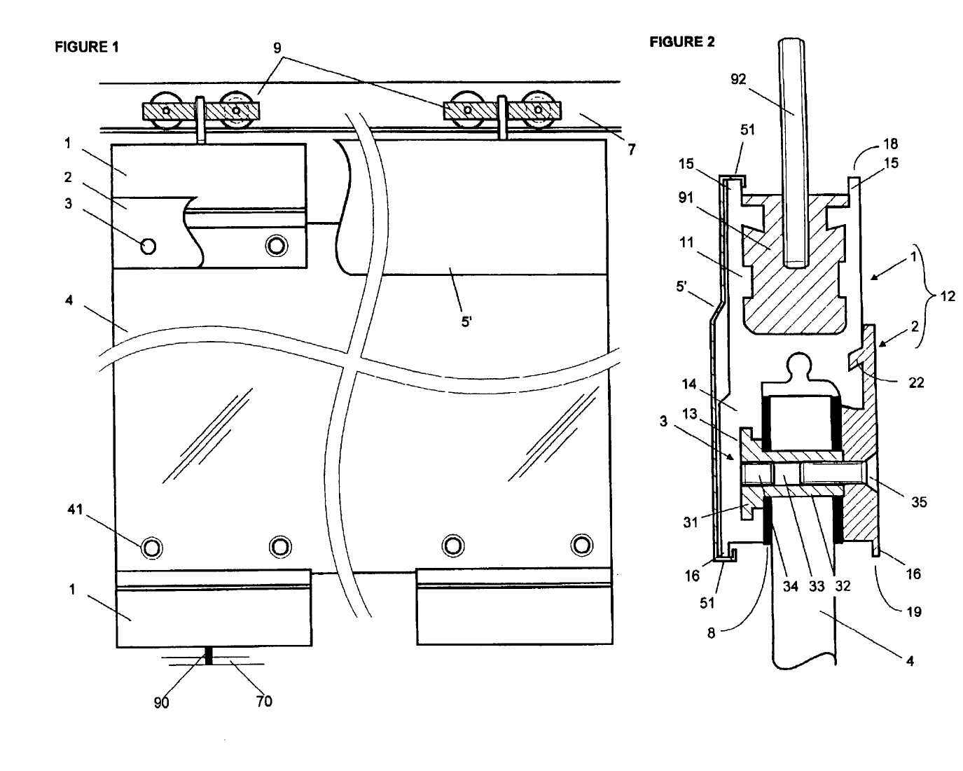

FIG. 1 shows a sliding door which is guided by means of running gear units 9 and a guide pin 90 along an upper and lower rail 7, 70. The sliding door is provided with a device which has the purpose of securing a panel 4, in particular a glass panel, in a positively locking fashion.

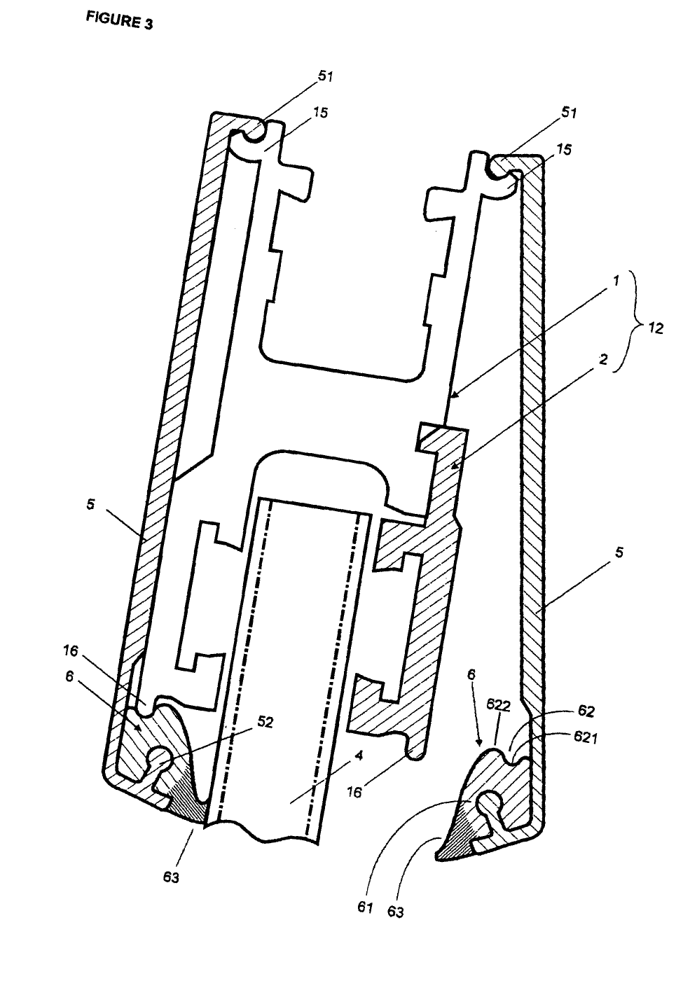

This device which is illustrated in a side view in FIG. 2 has at least one supporting element 3 which is led through an opening 41 in the glass panel 4 and by means of which a first profiled piece 1 and a second profiled piece 2, which are arranged on opposite sides of the glass panel 4 with respect to one another can be connected to one another. The supporting element 3 has a head component 31 which is secured in a displaceable fashion in a receiving groove 13 which is provided in the first profiled piece 1, as well as a connecting component 32 which is to be led through the opening 41 and has a threaded bore 33 which is provided for receiving a mounting screw 35 which has the purpose of connecting the second profiled element 2. A threaded pin 34 by means of which the supporting element 3 can be fixed within the securing groove 13 is also arranged inside the threaded bore 33.

The glass panel 4 can therefore be fitted onto supporting elements 3 which are inserted into the first profiled piece 1 and displaced into a desired position. After the supporting elements 3 are fixed, the second profiled piece 2 is fitted on and screwed, as a result of which the glass panel 4 is clamped tight.

The two profiled pieces 1 and 2 which are connected to one another form a profiled element 12 which is provided, on the upper edge and lower edge 18, 19, with securing elements 15, 16, cams, strips or wing elements which have the purpose of attaching a cover panel 5 on the lower and upper sides of which clamp-like connecting means 51, which are for the purpose of engaging around the securing elements 15, 16 in a clamping fashion, are provided. In order to avoid vibrations of the panel 4, preferably elastic belts 8, which are slightly compressed when the mounting screws 35 are tightened are provided between the two profiled elements 1, 2 and the glass panel 4 (as illustrated in FIG. 2).

A mounting block 91, which is connected to an associated running gear unit 9 (see FIG. 1) is inserted into the profiled element 12.

From FIG. 2 it is apparent that, in order to mount the cover panel 5, it has either to be inserted laterally over the upper and lower securing element 15, 16 or bent in such a way that, after it has been fitted on one side into a first upper or lower securing element 15 or 16, it can be guided on the other side by means of the second lower or upper securing element 16 or 15. Both methods which have the purpose of connecting the cover panel 5 to one of the profiled parts 1, 2 in a positively locking fashion cannot be carried out easily.

From FIG. 2 it is also apparent that when the cover panel 5 is fitted on the lower edge of the two profiled parts 1, 2 is exposed, for which reason soiling may occur in the joint region between the glass panel and the mounting device which is formed by the two profiled parts 1, 2, which soiling has to be removed in each case with a corresponding degree of expenditure.

In order to avoid disruptive soiling it would be possible to apply a seal, for example a silicone paste, in the aforesaid joint region or to configure the elastic belts 8 in such a way that they slightly overlap the two profiled parts 1, 2 and thus form seals.

However, these measures are associated with additional expenditure in terms of work and cost. In addition, after the application of the aforesaid measures, the joint region between the cover 5 and the glass panel 4 is also still exposed.

The present invention is therefore based on the objective of providing a device which can be manufactured cost-effectively and by means of which a first component, in particular a cover panel, can be connected to a second component, in particular a profiled component, in a positively locking but detachable fashion and by means of which the joint region between the first component and the third component can be reliably sealed. In addition, a cover device which is provided with this connecting device and a door element which is provided with the cover device are to be provided.

This object is achieved by means of a device and a dividing element which have the features specified in claims 1, 9 and 12. Advantageous refinements of the invention are given in further claims.

The device according to the invention has the purpose of connecting a first component to a second component in a positively locking but detachable fashion, and of sealing a joint region between the first component and a third component which is connected to the second component. According to the invention an elastic element is provided which has

a) a groove for receiving a securing rib which is provided on the first component,

b) a latching element which can be connected in a positively locking fashion to the second component by means of pressure force, and

c) a sealing lip which presses against a third component after the latching element latches in.

The first component, for example a cover panel, is therefore connected to the elastic element in a positively locking fashion by inserting the securing rib, as a result of which the cover panel is connected to the second component, for example a profiled part, in a positively locking fashion by means of the elastic element. The sealing lip is arranged here on the elastic element in such a way that, after the cover panel has been mounted, it presses against a third component, for example a glass panel of a dividing element, which is connected to the profiled part.

After the cover panel has been connected to the profiled part, the joint region between the cover panel and the glass panel is therefore closed off in a sealed fashion so that the cover panel and the profiled part are connected to one another in a positively locking fashion, and the cover panel and the glass panel are connected to one another in a frictionally locking fashion.

By using the device according to the invention it is therefore possible to avoid the use of further sealing materials, silicone pastes or rubber seals. There is thus a resulting saving in terms of material and a reduced expenditure in terms of work as, by mounting the cover panel, not only is the connection to the profiled component brought about but also the joint region between the cover panel and glass panel is sealed.

A dividing element, for example a sliding door, which is provided with the cover according to the invention can therefore be cleaned without difficulty. In addition, by covering unattractive joint regions it is possible to improve the aesthetic appearance of the dividing element which is provided with the cover device.

The sealing lip is preferably made more flexible than the rest of the body of the elastic element so that the cover panel and the profiled element can be connected to one another in a stable but detachable fashion, and the sealing lip is deformed as a result of the pressing against the glass panel, as a result of which the sealing panel bears against the glass panel by means of surface pressure.

The desired elasticity of the sealing lip and of the rest of the body of the elastic element can be brought about by the selection of the material for each component of the elastic element and/or also by shaping.

For example, the sealing lip has a hardness of less than 50 Sh_A (Shore A), preferably approximately 10 Sh_A to 30 Sh_A, and the other components of the elastic element have a hardness of greater than 50 Sh_A, preferably approximately 70 Sh_A to 90 Sh_A. (Shore A corresponds to standard DIN 53505 and is applied with soft rubber, elastomers and natural rubber products).

The elastic element according to the invention is preferably fabricated from one piece. The sealing lip can however also be connected to the rest of the body of the elastic element by means of an adhesive or welded.

If the elastic element is fabricated in one piece, for example two starting materials with appropriate material properties are combined and extruded in such a way that the partial regions of the elastic element have the desired material hardnesses.

The latching element has a shape which is matched to a securing element and can preferably be compressed with the body of the elastic element in such a way that it can be displaced over, under or into the securing element and relaxes again as it bears against the securing element in a positively locking fashion.

In one preferred refinement, the body of the elastic element has a compression groove which runs in the axial direction and which is deformed as soon as the pressing force acts on the latching element.

The cover device is composed of a cover panel with a securing rib onto which the elastic element is fitted. The cover panel preferably has second connecting means by means of which it can be connected on one side to the profiled part. For example, the cover panel is fitted by means of a second connecting means onto an upper securing element which is provided on the upper edge of the profiled component, after which the latching element is pressed through under the lower securing element which is provided on the lower edge of the profiled component.

The latching element can, for example, also be led through under a lower securing element which is provided on the lower edge of the profiled part, after which the cover panel is lifted up and the elastic element is compressed, with the result that the second connecting means can be led over the upper securing means and fitted onto them.

A profiled part which is connected to the glass panel therefore preferably has, on one or both sides, in each case two securing elements which are preferably arranged on its upper edge and lower edge and to which the second connecting means and the latching element which is provided on the elastic element can be connected in a positively locking fashion.

A dividing element, for example a sliding door (see FIGS. 1 and 2) which is provided with a glass panel can therefore be provided with the cover device according to the invention with a small number of manoeuvres, after which the joint region between the cover panel of the cover device and the glass panel is also closed off in a sealed fashion.

The invention is explained in more detail below with reference to drawings, in which:

FIG. 1 shows a sliding door which is guided by means of running gear units 9 and a guide pin 90 along an upper and a lower rail 7; 70 and which is provided with a device for securing a glass panel,

FIG. 2 shows the device from FIG. 1 in a sectional side view illustrated with a two-piece profiled element 12 to which a cover panel 5′ is attached,

FIG. 3 shows the profiled element 12 from FIG. 2 with upper and lower securing elements 15, 16 which are preferably configured and to which cover devices according to the invention, which are composed of a cover panel 5 and an elastic element 6, can be attached,

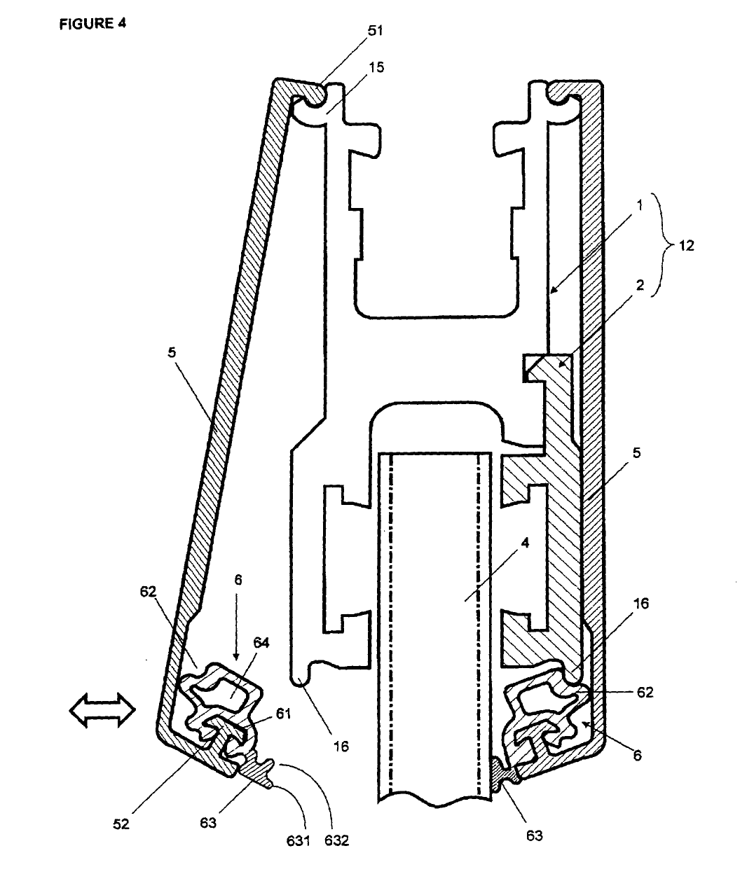

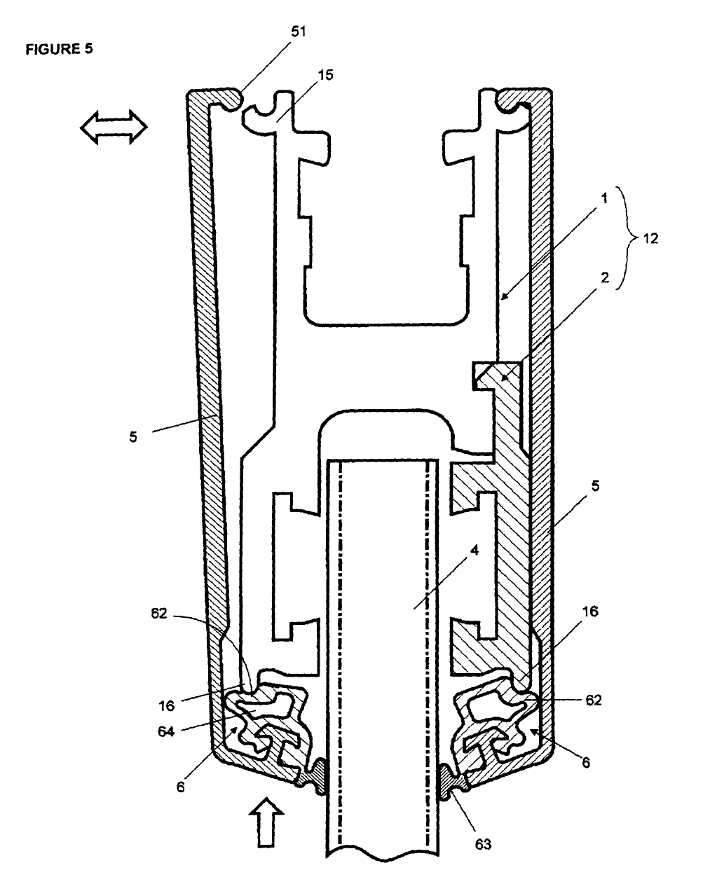

FIG. 4 shows, in a preferred configuration, the cover devices from FIG. 3, one of which is fitted to the profiled element 12 at the top and is pressed at the bottom against the profiled element 12,

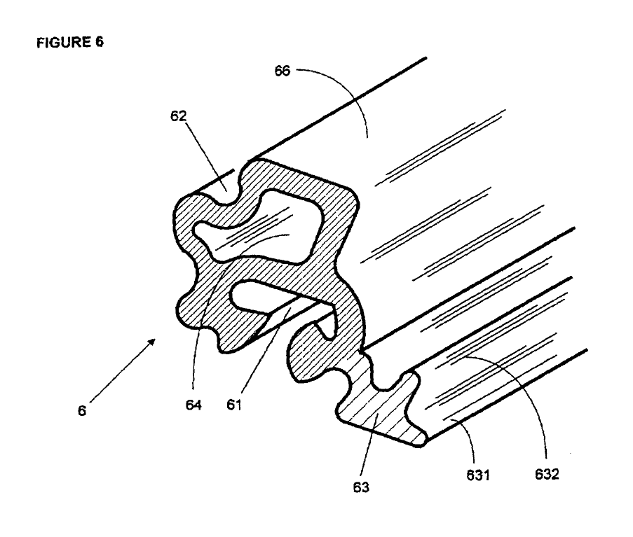

FIG. 5 shows the cover devices from FIG. 4, one of which is fitted to the profiled element 12 at the bottom, is lifted up and is pressed at the top against the profiled element 12, and

FIG. 6 shows the elastic element 6 in the configuration from FIG. 4.

FIG. 1 shows the sliding door which is described in the introduction, is provided with a glass panel 4 and is guided along an upper and a lower rail 7, 70 by means of running gear units 9 and a guide pin 90. The sliding door is provided with the device which is shown in a sectional view in FIG. 2 and which has the purpose of securing the glass panel 4 in a positive locking fashion.

This device which is illustrated in a side section in FIG. 2 has at least one supporting element 3 which can be led through an opening 41 in the glass panel 4 and by means of which a first profiled piece 1 and a second profiled piece 2, which are arranged on opposite sides of the glass panel 4 with respect to one another can be connected to one another. The two profiled pieces 1 and 2 which are connected to one another form a profiled element 12 which is provided on their upper and lower edges 18, 19 with securing elements 15, 16, cams or wing elements, which have the purpose of attaching a cover panel 5.

FIG. 3 shows the profiled element from FIG. 2 with upper and lower securing elements is, 16 in a preferred configuration, and two cover devices according to the invention which are composed of a cover panel 5 and an elastic element 6 which is mounted thereon. The cover panels 5 are provided on the underside with an axially extending securing rib 52 which has the purpose of securing the elastic element 6, and are provided on the upper side with a wing-like connecting means 51 which serves as a second connecting element for fitting the cover panel 5 to the upper securing elements 16 of the profiled part 12.

The elastic element 6 has a groove 61 for receiving the securing rib 52, and a latching element 62 which is provided with a depression 621 which has the purpose of receiving a securing element 16, and a projection 622 which has the purpose of locking the securing element 16. In addition, the elastic element 6 is provided with a sealing lip 63 which, after the cover device has been mounted, presses against the glass panel 4 which is secured by the profiled element 12.

As is shown in FIG. 3, when the cover panel 5 is mounted it is, for example, firstly fitted onto the upper securing element 15, as a result of which the underside of the cover panel 5 which is provided with the elastic element 6 is pressed against the lower securing element 16 until the projection 622 slides through under the lower securing element 16 into the depression 621, as a result of which the positively locking connection between the profiled element 12 and the cover device is formed.

As is shown in FIG. 3, the sealing lip 63 is arranged here on the elastic element 6 in such a way that it presses against the glass panel 4 after the cover panel 5 has been mounted.

After the cover panel 5 has been connected to the profiled part 12, the joint region between the cover panel 5 and the glass panel 4 is therefore closed off in a sealed fashion, with the result that the cover panel 5 and the profiled part 12 are connected to one another in a positively locking fashion, and the cover panel 5 and the glass panel 4 are connected to one another in a frictionally locking fashion.

The sealing lip 63 is preferably made more flexible than the rest of the body 66 of the elastic element 6 so that the cover panel 5 and the profiled element 12 can be connected to one another in a stable but detachable fashion, and the sealing lip 63 is deformed by the pressing against the glass panel 4, as a result of which the sealing lip 63 bears against the glass panel 4 by means of surface pressure.

The desired elasticity of the sealing lip 63 and of the rest of the body 66 of the elastic element 6 can be brought about by means of the selection of the material for each part of the elastic element 6 and/or also by its shaping.

For example, the sealing lip 63 has a hardness of less than 50 Sh_A (Shore A), preferably approximately 10 Sh_A to 30 Sh_A, and the other components 66 of the elastic element 6 have a hardness of greater than 50 Sh_A, preferably approximately 70 Sh_A to 90 Sh_A. Shore A corresponds to Standard DIN 53505 and is applied with soft rubber, elastomers and natural rubber products which can be used for manufacturing the elastic component 6. For the sealing lip 63 it is, for example, also advantageously possible to use cellular rubber.

However, the sealing lip 63 can also be relatively thin and long so that it can easily be pressed against the glass panel 4.

The elastic element 6 is preferably fabricated from one piece. The sealing lip 63 can however be connected by means of an adhesive or welded to the rest of the body 66 of the elastic element 6.

If the elastic element 6 is fabricated in one piece, for example two starting materials with appropriate material properties are combined and extruded in such a way that the partial regions of the elastic element have the desired material hardnesses.

FIG. 4 shows the cover device in a preferred configuration with an elastic element 6 which has a compression groove 64 which extends in a longitudinally axial fashion and which is deformed as soon as a pressure force acts on the latching element 62, with the result that the cover device can be mounted and dismounted without difficulty.

By pulling on the underside of the cover device it is possible to release it from the profiled element 12 again. As shown in FIG. 5, the mounted cover device can also be pressed upwards so that the upper connecting means 51 becomes released from the upper securing element 15, and the cover device can be removed again. The cover device can of course also be mounted again in the same way. In this case, the latching element 62 is fitted to the lower securing element 16, after which the cover device is pressed upwards until the second connecting means 51 which is provided on the cover panel can be introduced into the upper securing element 15 which is provided on the profiled element 12.

FIG. 6 shows the elastic element 6 in detail. Here, it is apparent that the sealing lip 63 is composed of a lower lip 631 and an upper lip 632, which are unfolded after the cover device has been mounted, and pressed in a wide fashion against the glass panel 4.

The connecting device according to the invention has been described and presented in a preferred embodiment. However, further configurations can also be implemented by a person skilled in the art by reference to the teaching according to the invention. In particular, various configurations and dimensions of the components of the device can be selected, and various fabrication materials can be used to manufacture it. In addition, the elastic element 6 can also be configured in such a way that the positively locking connection between the first and second components is possible without additional connecting elements.

List of Reference Numbers

1 First profiled piece

11 Upper component of the profiled element 12

12 Profiled element composed of the first and second profiled pieces 1, 2

13 Receiving groove

14 Lower component of the profiled element 12

15 Upper securing element

16 Lower securing element

18 Upper edge of the profiled element 12

19 Lower edge of the profiled element 12

2 Second profiled piece

22 Mounting rib

3 Supporting element

31 Head component

32 Connecting component

33 Threaded bore

34 Threaded pin

35 Mounting screw

4 Glass panel

41 Hole in the glass panel 40

5 Cover panel

51 Connecting means

52 Securing rib

6 Elastic element

61 Groove for receiving the securing rib 52

62 Latching element

621 Depression

622 Projection

63 Sealing lip

631 Upper lip

632 Lower lip

64 Compression groove

66 Body

7 Upper guide rail

70 Lower guide rail

8 Elastic belts

9 Running gear unit

90 Guide pin

91 Mounting block

92 Connecting screw

1. Device for connecting a first component (5) to a second component (12) in a positively locking but detachable fashion, and for sealing a joint region between the first component (5) and a third component (4) which is connected to the second component (12), characterized in that an elastic element (6) is provided which has
a) a groove (61) for receiving a securing rib (52) which is provided on the first component (5),
b) a latching element (62) which can be connected in a positively locking fashion to the second component (12) by means of pressure force, and
c) a sealing lip (63) which presses against the third component (4) after the latching element (62) latches in.

2. Device according to claim 1, characterized in that the elastic element (6) is fabricated from one piece, or in that the sealing lip (63) is connected by means of an adhesive or welded to the rest of the body (66) of the elastic element (6).

3. Device according to claim 1 or 2 characterized in that the sealing lip (63) is configured so as to be more flexible than the rest of the body (66) of the elastic element (6) which is provided with the groove (61) and the latching element (62), with the result that the first and second components (5, 12) are held in a stable fashion after the mutual, positively locking connection, and the sealing lip (63) is deformed as a result of pressing against the third component (4).

4. Device according to claim 3, characterized in that the elasticity of the sealing lip (63) and of the rest of the body (66) of the elastic element (6) is brought about by the selection of material or by the shaping.

5. Device according to claim 4, characterized in that the sealing lip (63) has a hardness of less than 50 Sh_A, preferably approximately 10 Sh_A to 30 Sh_A, and the other components of the elastic element (6) have a hardness of greater than 50 Sh_A, preferably approximately 70 Sh_A to 90 Sh_A.

6. Device according to claim 5, characterized in that the body (66) and/or the sealing lip (63) are fabricated from soft rubber, elastomers, natural rubber, and the sealing lip (63) is fabricated in particular from cellular rubber.

7. Device according to one of claims 1 to 6, characterized in that the latching element (62) can be pressed into the body (66) of the elastic element (6).

8. Device according to one of claims 1 to 7, characterized in that the body (66) of the elastic element (6) has a compression groove (64) which runs in the axial direction and which is deformed as soon as the pressure force acts on the latching element (62).

9. Cover device having a connecting device according to one of claims 1 to 8, characterized in that the first component (5) has a cover panel, the second component (12) is a profiled component which is to be covered by the first component (5) and is composed, if appropriate, of two or more pieces (1, 2), and the third component (4) is a panel, in particular a panel of glass which is held at least on one side by means of the second component (1, 2).

10. Cover device according to claim 9, characterized in that the cover panel (5), on whose securing rib (52) the elastic element (6) is fitted, has second connecting means (51) to which the cover panel (5) can be connected on one side by means of the profiled component (12).

11. Cover device according to claim 10, characterized in that the profiled component (12) which is connected to the glass panel (4) has, on one or both sides, in each case two securing elements (15, 16) which are preferably arranged on its upper edge and lower edge and to which the second connecting means (51) and the latching element (62) which is provided on the elastic element (6) can be connected in a positively locking fashion.

12. Dividing element, in particular a sliding door, having a profiled component (12) which has the purpose of securing a panel (4) in particular a glass panel and which is covered by means of a cover device according to one of claims 9 to 11, in such a manner that the joint region between a cover panel of the cover device and the panel (4) is covered in a sealed fashion.
